(19) United States
(12) Patent Application Publication
(10) Pub. No.: US 2009/0127803 A1
(43) Pub. Date: May 21, 2009

(54) Pipe Coupling Adapted for Sealing the End of a Pipe

(75) Inventors: David Chelchowski, South Australia (AU); Geoffrey Brian Puckett, South Australia (AU); Malcolm Pridham, South Australia (AU)

Correspondence Address: Ralph C. Francis;Francis Law Group, 1942 Embarcadero, Oakland, CA, 94606, US

(73) Assignee: PHILMAC PTY LTD, North Plympton S.A. (AU)

(21) Appl. No.: 10/576,558

(22) PCT Filed: Oct. 12, 2005
(86) PCT No.: PCT/AU2005/001582

§ 371 Date: Jan. 27, 2009

(51) Int. Cl. F16L 21/04; F16L 19/06

(52) U.S. Cl. 277/622; 285/343

(57) ABSTRACT

The present invention relates to a sealing member for use in a pipe coupling assembly and, in particular, to a sealing member for sealing the end of a pipe having an exposed metal surface at its end, such as pipes comprising an internal metal sheath which is lined internally and externally with plastic. The sealing member includes a pipe receiving portion adapted to receive the end of the pipe to thereby prevent contact between the end of the pipe and fluid travelling through the pipe. The sealing member may be used in standard pipe couplings, or is preferably incorporated into a coupling having a deformable gripping member whereby upon tightening of the coupling assembly nut, the gripping member urges against the pipe both radially and longitudinally to thereby simultaneously grip the pipe and urge the pipe end within the pipe receiving portion.

### FIELD OF THE INVENTION

The present invention relates to a pipe coupling and, in particular, to a sealing member for use in a pipe coupling assembly adapted for sealing the end of a pipe having an exposed metal surface.

### BACKGROUND OF THE INVENTION

The present inventor is the owner of a number of patents dealing with pipe couplings, including PCT/AU02/00487 which relates to a pipe coupling assembly that provides an advantage in that it is significantly shorter than other known pipe coupling assemblies, making it suitable for use in applications such as homes and in meter boxes. The pipe coupling assembly generally includes a nut, a body, a gripping member and a seal or o-ring. The nut engages the body through appropriate threads and includes a hooked projection having a sloping surface adapted to abut against and provide a force on a corresponding sloping surface of the gripping member within the body. A pipe is inserted through the nut, gripping member and seal into the body. Tightening of the nut causes its sloped surface to engage the corresponding sloping surface of the gripping member and thereby causes the front portion of the gripping member to move radially, and the whole of the gripping member to move longitudinally. The radial force causes barbs on the inner side thereof to move radially inwards. The longitudinal force causes the pipe to be urged into the body and in doing so causes it to abut against and compress the seal, whilst dragging the pipe further into the body.

The type of pipe coupling embodied in PCT/AU02/00487 is incorporated by reference herein. It is to be understood though that this is by way of example only, and that other configurations of pipe coupling may well be used. For example, the abovementioned hooked projection which causes the gripping member to move radially inwardly upon tightening of the nut is not necessarily a feature that is essential to the working of the present invention. The present invention could well be incorporated into standard couplings and any other of the present inventors' couplings, for example, that which is disclosed in PCT/AU01/01665 entitled “Coupling body for polymeric pipes including a pipe abutment surface”.

Pipes adapted to carry potentially corrosive material, in particular liquids such as water and acids, are well known and such piping is used across many industries, from small scale use such as in household plumbing, to larger scale use such as in oil rigs for example. It would therefore be preferable for piping to be constructed of corrosion-proof material such as stainless steel, however, it is often not feasible to produce pipes made of such material because of the expense involved. Also, pipes made purely of metal are not suitable for applications that require the pipe to be flexible.

A further problem encountered in potable water pipes is that they may be placed in areas where there is external pollutants and where the water within the pipes needs to be protected from external contamination.

Accordingly, much piping nowadays is made of up of an internal sheath of metal that is lined internally and externally with plastic material. The metal sheath, which can be quite thin, maintains strength within the piping whilst the plastic lining provides the pipe with its required width, thereby reducing manufacturing costs significantly. Such piping is now well known.

A problem arises through use of these pipes where lengths of pipe need to be coupled together, or coupled to any other existing pipe. When a pipe is cut, the internal metal sheath becomes exposed and in using pipe couplings such as that which is described in PCT/AU02/00487, that is, where the gripping member simply pushes longitudinally against the o-ring, it has been found that there is insufficient protection between the exposed metal and the liquid travelling through the pipe. This results in corrosion and erosion of the metal at the end of the pipe within the pipe coupling. The adverse consequences of corrosive material entering the stream of liquid which travels through the pipe are well known. For example, if the liquid is water intended to be consumed by humans, rust and other corrosive material introduced into the liquid may be potentially harmful. Further, some applications involve the transportation of highly pure or concentrated material through such pipes, whereby any form of contamination will have adverse effects.

It is therefore an object of the present invention to provide a pipe coupling assembly that overcomes the abovementioned problems or at least provides the public with a useful alternative.

### SUMMARY OF THE INVENTION

Therefore in one form of the invention there is proposed a sealing member for use in a pipe coupling assembly of the type adapted to engage an end of a pipe having an exposed metal surface, said sealing member characterised by a pipe receiving portion adapted to sealably receive the end of the pipe to thereby prevent contact of the exposed metal surface with liquid travelling through the pipe.

Preferably said sealing member further includes an o-ring portion that is adapted to provide a seal between the pipe and the pipe coupling assembly.

In preference the sealing member is integrally formed and adapted to be positioned within the pipe coupling assembly so that the pipe receiving portion is located in a position rearwards of the o-ring portion, the pipe receiving portion and o-ring portion being joined by an annular wall of predetermined longitudinal length.

In preference the o-ring portion extends substantially outwardly from the annular wall and said pipe receiving portion extends substantially inwardly from the annular wall.

Preferably the pipe receiving portion is in the form of an annular channel including a base surface which extends inwardly from the annular wall substantially perpendicularly to the longitudinal axis of the coupling, said base surface adapted to abut with the exposed metal surface of the pipe end when the pipe is fully received within the pipe receiving portion. This ensures that corrosion through contact of the metal with fluid travelling through the pipe will not take place at the pipe coupling.

In preference the pipe receiving portion further includes an internal wall defining a central bore of the sealing member, said internal wall extending forwardly from the internal edge of the base surface so that when the pipe end is fully received within the pipe receiving portion, the internal wall lines the internal edge of the pipe end.

Preferably when the pipe end is fully received within the pipe receiving portion of the sealing member, the base surface and internal wall of the pipe receiving portion serve to prevent contact of liquid travelling through the central bore of the sealing member with the exposed metal surface of the pipe end.

Preferably the rearward end is substantially cylindrical and includes a plurality of tetrahedrally shaped grooves disposed radially thereabout.

In a further form of the invention there is proposed a pipe coupling assembly for connection of a pipe having an end with exposed metal, said pipe coupling assembly including:
a hollow body having an external thread extending at least in part therealong;
a nut threadably engaging said body external thread;
a sealing member including a pipe receiving portion; and
a deformable gripping member wherein upon tightening of said nut, a force is exerted on the gripping member both in the longitudinal and radial directions to thereby cause the gripping member to engage the pipe and drag it into the body so that the end of the pipe is received within the pipe receiving portion of the sealing member.

Preferably the hollow body includes an inner surface and a gripping member abutment surface disposed rearwardly from the inner surface.

In preference the sealing member further includes an o-ring portion adapted to sit between the gripping member abutment surface and the gripping member, said o-ring portion adapted to compress when said longitudinal force is applied to the gripping member.

In preference the sealing member is an integrally formed structure whereby the pipe receiving portion is disposed rearwardly from the o-ring portion and joined by an annular wall of predetermined length.

Preferably the pipe receiving portion is in the form of an annular channel including a base surface which extends inwardly from the annular wall substantially perpendicularly to the longitudinal axis of the coupling, said base surface adapted to abut with the exposed metal surface of the pipe end when the pipe is fully received within the pipe receiving portion.

In preference the pipe receiving portion further includes an internal wall defining a central bore of the sealing member, said internal wall extending forwardly from the internal edge of the base surface so that when the pipe end is fully received within the pipe receiving portion, the internal wall lines the internal edge of the pipe end.

In preference the nut includes at one end an internal thread co-operable with said body external thread and including a hooked projection adapted to extend over at least part of said body inner surface said projection including a first inner surface generally parallel to said body inner surface, a second outwardly converging surface extending from the inner edge of said inner surface.

Preferably the deformable gripping member includes a first surface generally parallel to said body inner surface and having a second outwardly converging outer surface extending from said first surface, said gripping member including radially inward barbs.

Preferably the gripping member moves sufficiently radially inwardly that the gripping member second surface is caused to slide inwardly against the nut second surface until in a fixed position at which time the body reinforces the nut against any radial force.

In preference the gripping member may be in the form of a collet that is split.

In preference the slope of the gripping member second surface is smaller than the slope of the nut second surface and is selected so that when the nut engages the gripping member and forces it into the body thereby compressing it, the slope of the gripping member second surface is generally the same as the nut second surface.

Preferably the slope of the gripping member second surface in its rest state is some 37 degrees, the slope of the nut second surface some 45 degrees.

In preference said nut further includes an annular shoulder extending radially inwardly from the edge of said nut second surface, said stop adapted to be abutted by said gripping member when in its compressed state to thereby provide a resistive force for the gripping member moving longitudinally out of the body.

Preferably the width of said nut second surface is greater than the width of the gripping member second surface to thereby accommodate said gripping member second surface sliding alongside said nut second surface as the nut is tightened whilst full surface contact between the two surfaces is maintained.

Advantageously the width of said nut second surface is some ⅓ greater than the width of the gripping member second surface.

### BRIEF DESCRIPTION OF THE PREFERRED EMBODIMENT

The accompanying drawings, which are incorporated in and constitute a part of this specification, illustrate an implementation of the invention and, together with the description, serve to explain the advantages and principles of the invention. In the drawings,

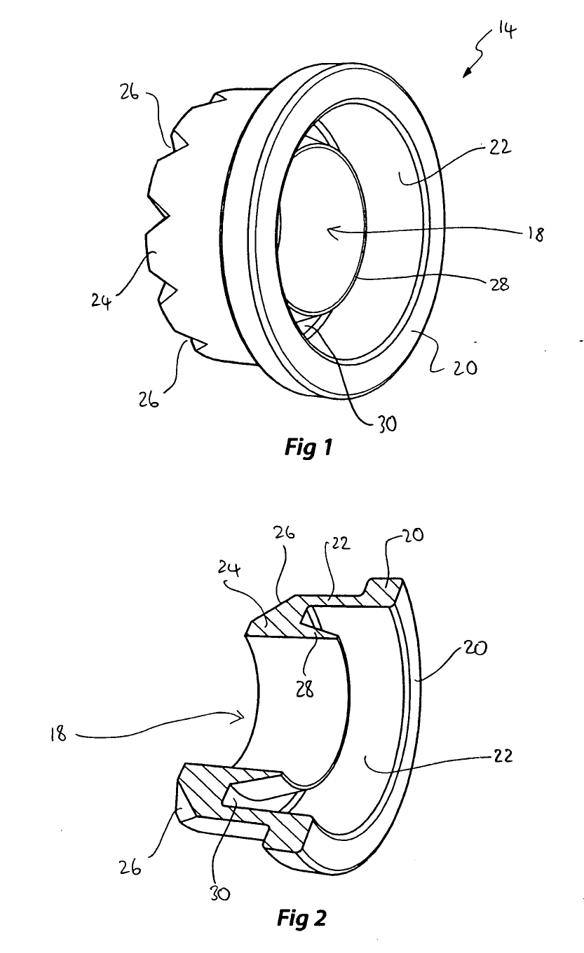

FIG. 1 illustrates a perspective view of a sealing member which forms part of a pipe coupling of the present invention;

FIG. 2 illustrates a cross-sectional perspective view of the sealing member of FIG. 1;

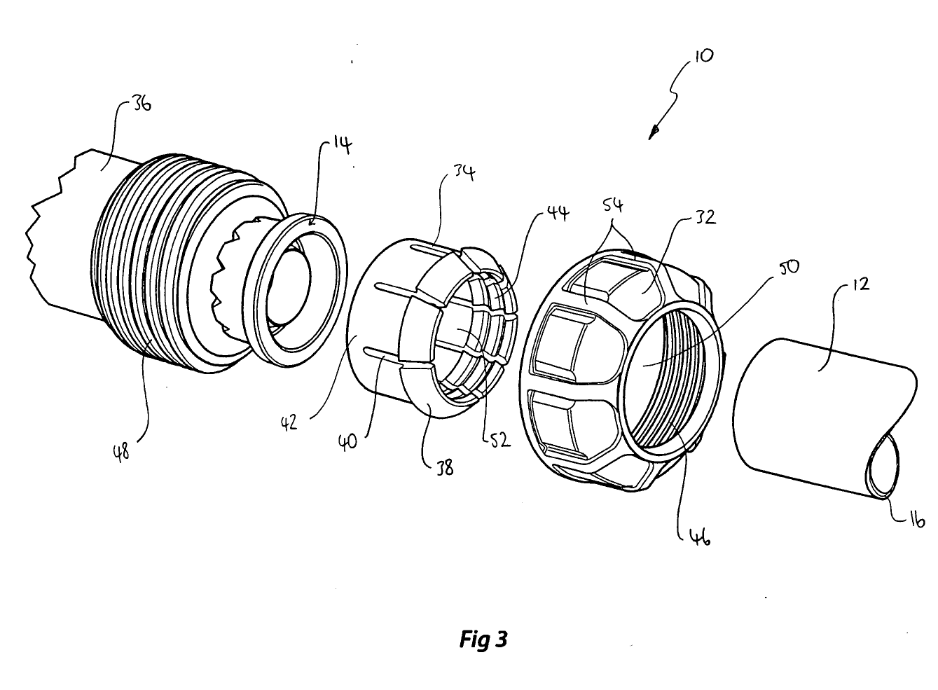

FIG. 3 illustrates an exploded view of the pipe coupling assembly of the present invention;

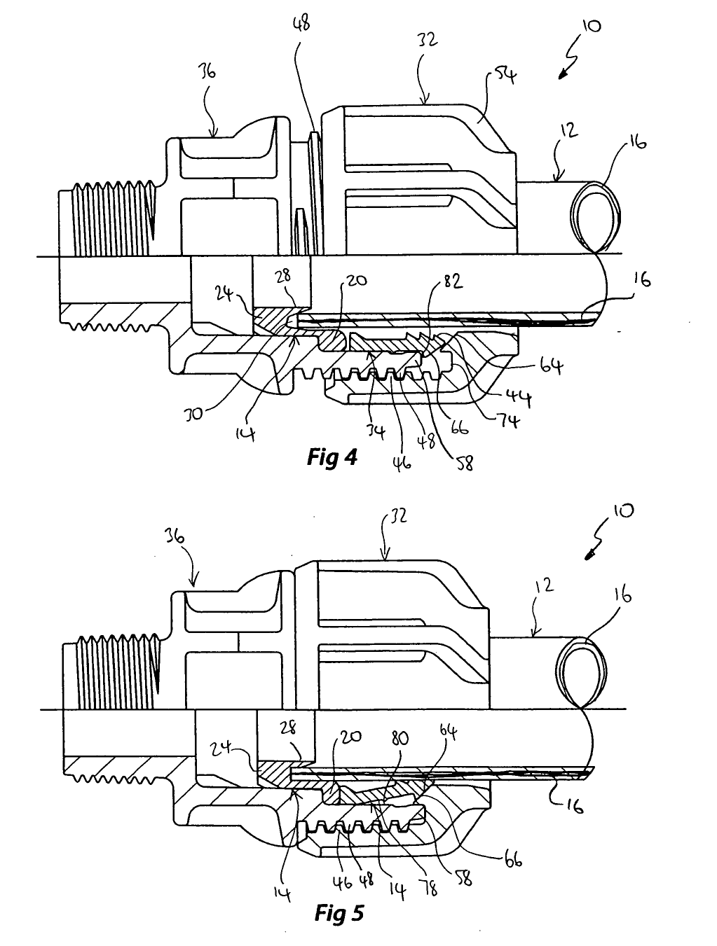

FIG. 4 illustrates a partial cross-sectional view of the pipe coupling assembly of FIG. 3 prior to the nut having been tightened;

FIG. 5 illustrates a partial cross-sectional view of the pipe coupling assembly of FIG. 3 when the nut has been fully tightened;

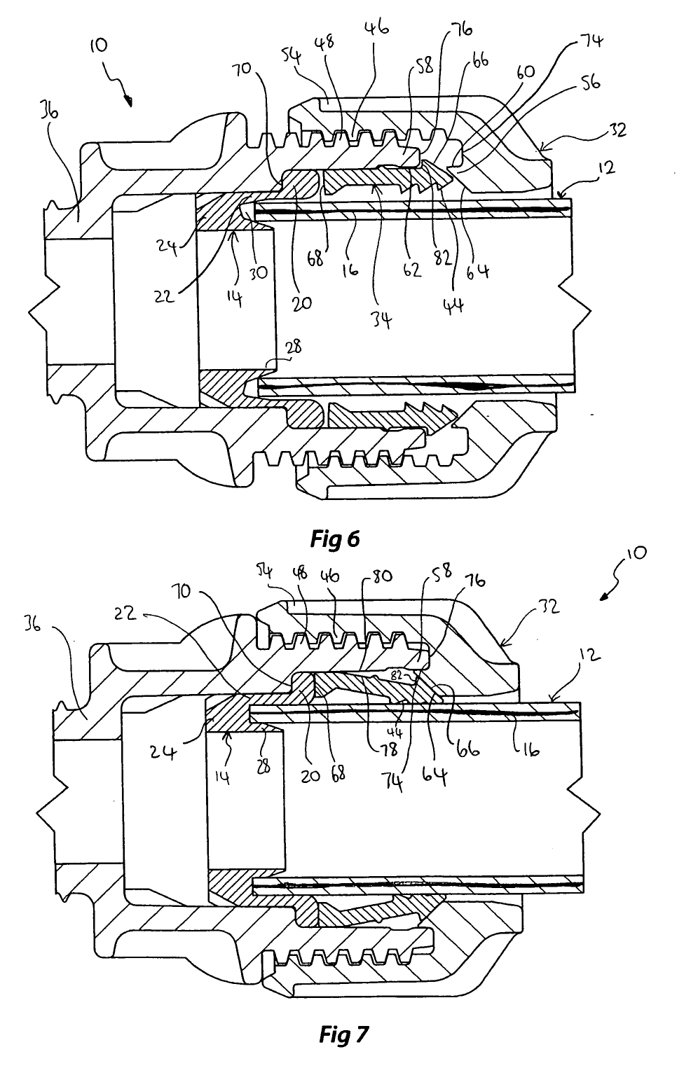

FIG. 6 illustrates a full cross-sectional view of the pipe coupling assembly as shown in FIG. 4; and

FIG. 7 illustrates a full cross-sectional view of the pipe coupling assembly as shown in FIG. 5.

### DESCRIPTION OF THE PREFERRED EMBODIMENT

The following detailed description of the invention refers to the accompanying drawings. Although the description includes exemplary embodiments, other embodiments are possible, and changes may be made to the embodiments described without departing from the spirit and scope of the invention. Wherever possible, the same reference numbers will be used throughout the drawings and the following description to refer to the same and like parts.

The present invention relates to a coupling assembly 10 for particular use in sealing the end of a plastic lined pipe 12 and preventing contact between the end of the pipe and the contents of the pipe. In brief, the pipe coupling assembly 10 may replace a conventional o-ring with an improved sealing member 14 configured to ensure that liquid or any other material travelling through the pipe does not contact the pipe end, and in particular the internal metal sheath 16 which is exposed at the pipe end, as well as its normal task of providing an effective seal.

The coupling is thus used on pipes as described. However in use it is typical that the user will cut the pipe and in doing so it will become somewhat flattened. Before the coupling and the seal incorporating the present invention can be used it is necessary to that the cut end of the pipe is generally circular. To this end a separate tool may be used on the open cut to bring the end of the pipe to a generally circular configuration.

FIG. 1 and FIG. 2 illustrate the sealing member 14 which is shaped to receive the end of the pipe 12 whilst allowing the flow of liquid through an aperture 18 extending therethrough. The shape of the sealing member 14 can best be appreciated by looking at its cross-section in FIG. 2 which shows that the member 14 is made up of an upper annular ring 20, a wall 22 extending downwardly from the ring 20 to a base 24 thereof whereby the external diameter of the ring 20 is greater than that of the wall 22, but their internal diameter is the same. The base 24 includes on its lower outer surface a plurality of radially disposed air pockets 26 each of which is formed by two cut-away surfaces forming a substantially tetrahedral shape. The sealing member 14 further includes a thin internal projection 28 which extends upwards from the base at a diameter that is less than the internal diameter of the wall 22 to thereby form an internal channel 30. Those skilled in the art will immediately realise that it is channel 30 which is adapted to receive the end of the pipe 12 while the internal projection 28 will line the internal surface of the pipe adjacent its end.

FIG. 3 illustrates the position of the sealing member 14 with respect to the other parts of the pipe coupling assembly 10. The skilled addressee will realise that the sealing member 14 simply replaces the use of a conventional o-ring. The working of the pipe coupling assembly 10 of the present invention will now be described in greater detail with reference to FIGS. 4-7 in particular.

As well as sealing member 14, the coupling assembly 10 includes a nut 32, a grip-ring or collet 34, and a body 36. The pipe 12 is adapted to be inserted through the nut 32 and grip-ring 34 into the body 36. The grip-ring 34 includes a front portion 38 having partial splits 40 since it must be radially and thereby circumferentially deformable, and a rear portion 42 which remains radially located within the body 36, that is, the collet 34 is imprisoned within the body and once located cannot expand. Although not shown, grip-rings of this type may also include a split for ease of manufacture so that they may easily be jumped off a moulding tool (not shown). The grip ring 34 further includes radially inwardly and axially spaced barb projections 44. The partial splits 40 of the collet 34 enable the front portion 38 of the gripping member 34 to be radially compressed so that the barbs 44 engage the pipe 12.

The nut 32 includes female threads 46 that engage corresponding male threads 48 on the body 36. In use and prior to tightening of the nut 32, pipe 12 is inserted though the aperture 50 of the nut 32 and through the bore 52 of the collet 34. To aid in rotating the nut 32, circumferential projections or ribs 54 assist with maintaining a hand or tool grip.

The nut 32 includes a hooked projection 56 extending or enveloping around end 58 of the body 36 and having an inner surface 60 parallel to inner surface 62 of the body 36, both surfaces generally parallel to the longitudinal axis of both the coupling and the pipe. The surfaces are adjacent each other so that as the nut is tightened the nut inner surface 60 slides alongside the body inner surface 62. Although not shown, these surfaces may also be tapered, typically at an angle of a few degrees, which has the combined effect of reinforcing that section of the nut 32 since any outward radial forces experienced by the nut are also transferred to the body. The nut is effectively “tied” to the body and together they form a more rigid assembly.

The reinforcing also assists in resisting bending forces that may be applied by the pipe 36 to the coupling 10. The interlocking between the nut and the body prevents the nut 32 from moving on the body and thus ensures a seal is maintained.

The hooked projection 56 further includes an inwardly diverging surface 64 whose surface has a shape and slope correspondingly matching the outwardly converging tapered surface 66 on the collet front portion 38. As the nut 32 is tightened the nut surface 64 abuts and bears against the collet surface 66. Since both the nut and the collet surfaces are at an angle to the longitudinal axis of the coupling 10, the collet 34 will experience both a radial and a longitudinal force.

The pipe 12 is adapted to be inserted into the body 36 until the end of the pipe 12 abuts with the channel 30 of the sealing member 14. Each side of the channel 30 is slightly tapered at this point and terminates into an area that is smaller than the pipe width. As will become apparent though, as the pipe end moves further within the channel 30, the sides of the channel 30 will take the form of the pipe end. With the nut 32 in the unscrewed position, the barbs 44 have not engaged the pipe 12, and the surfaces 64 and 66 of the nut 32 and the collet 34 respectively are apart.

As mentioned, initial tightening of the nut 32 on the body 36 will cause abutment of the nut surface 64 against the corresponding surface 66 of the collet 34. The radial force compresses front portion 38 and causes the barbs 44 to bite into and engage the pipe 12, thereby dragging it into the body 36 and further toward channel 30 of the sealing member 14.

Simultaneously, rear surface 68 of the rear portion 42 of the collet 34 abuts and begins to compress the upper annular ring 20 of the sealing member 14 that is trapped between the collet 34 and an inner abutment surface 70 of the body to provide a seal for not only the pipe 12 but more specifically for the pipe end which has the metal reinforcing sheath 16 exposed. It is important for the abutment between these surfaces to be uniform across the entire surface, a factor that will be later discussed. As one further tightens the nut 32, the nut stop surface 74 approaches the body stop surface 76 and the space in between the two is progressively reduced as the nut is tightened. Of course, in some instances, the sealing member 14 may be attached to the collet 34 through its upper annular ring 20 with the ring then compressing against the body inner abutment surface 70.

Further tightening of the nut compresses the upper annular ring 20 of the sealing member 14 while the pipe end proceeds further within channel 30. During this process, the front portion 38 of the collet 34 is radially compressed even further so that its outer surface 78 moves away from the inner surface 80 of the body 36, that is, it bends inwards. The nut can then travel further until either the nut stop surface 74 and the body stop surface 76 abut, or the collet 34 resists any further radial and longitudinal motion. This now indicates to the user that an effective seal has been effected, as well as ensuring that the exposed metal 16 at the pipe end will not contact liquid travelling through the pipe 12. FIG. 5 and FIG. 7 illustrate the nut being fully tightened on the body where the inward bending of the collet, as well as engagement of the pipe end within channel 30 of the sealing member, is clearly visible. It will be appreciated that the internal projection 28 of the sealing member 14 lines the internal surface of the pipe adjacent its end which is essentially what prevents the contents of the pipe 12 from contacting the metal sheath 16.

Those skilled in the art will appreciate that the configuration of the coupling assembly of as described above provides for a working surface that by exerting a force on the gripping member causes both a seal of the coupling to a pipe, a holding force resisting the pipe from disengaging from the coupling, as well as a means of ensuring that corrosion does not form at the end of the pipe. This pipe coupling assembly may be constructed from moulded plastic or machined metal.

The present configuration also assists in securing a pipe to the coupling when a tensile or axial load is applied to the pipe. As a load is experienced by the pipe causing it to experience a force in the longitudinal direction out of the body 36, the configuration of the surface 64 and 66 on the nut 32 and collet 34 respectively results in the collet 34 further being compressed as it is pulled outwardly from the body. One potential difficulty with this type of arrangement is that the compression on the seal is reduced. For that reason it is important that care be paid to the relative slope of the surfaces on the nut and the gripping member. On the one hand one desires to have a slope so that tightening or screwing of the nut results in the compression of the gripping member to engage the pipe. On the other hand one has to ensure that the angle is not so great that a longitudinal force on the pipe will allow for excessive movement of the gripping member outwardly of the body.

The angle of the slopes of the surfaces 64 and 66 may be set generally at an angle of 45 degrees. However, the angle may be modified so that different ratios of forces on the collet 34 can be chosen. For example, if the angle of the slope in relation to the longitudinal axis of the coupling is 30 degrees then the ratio of the longitudinal to the radial forces experienced by the collet is no longer 1:1 but will be related to the sine of the angle. Changing this angle then allows one to control the relative forces experienced in the two directions.

Collet 34 further includes a lip 82. Inclusion of the lip 82 overcomes potential operating difficulties in that when coupling 10 has been assembled with a pipe 12, lateral forces exerted on the pipe may move the front surface 66 of the collet 34 across the surface 64 of the nut 32, much like that seen in ball-joint arrangements. The lip 82 therefore reinforces the collet 34 by providing an extra support point along its length that engages the body 36 when the nut 32 is in a tightened position. The lip 82 is initially of a greater diameter than the inner diameter of the body at end 58 in that it can sit flush against part of the body stop 76 when in an uncompressed state. When the nut is being tightened the collet front portion 38 then slips into the body under the longitudinal and radial forces exerted by the nut. Although not shown, it should be understood that the angle between the lip and the gripping member is of an arcuate shape rather than being a right angle and that assists in the collet slipping into the body and over the body end 58.

As the collet slides into the body, the edge of the lip 82 abuts the inner body surface so that the collet engages the body both at the front and its rear ends thus ensuring that it resists rotation with respect to the body, that is, its longitudinal axis remains generally co-axial with the rest of the coupling even when a lateral force is applied to the pipe and the collet.

The lip 82 on the collet also provides the additional advantage in assembly of the coupling. When the collet is being inserted into the body, use of the lip 82 ensures that it is inserted in the right orientation. Further, to further assist in securing the pipe within the body of the coupling the nut may include a stop (not shown) that prevents the collet 34 from being pulled out of the body 36 when the coupling is in the tightened state.

Those skilled in the art should now appreciate the advantages of the pipe coupling assembly of the present invention. The pipe coupling assembly provides for an effective water-tight seal between the pipe and the pipe coupling, as well as providing a means of ensuring that the exposed metal sheath at the pipe end which extends into the body does not contact liquid travelling therethrough.

It is to be understood that although the above description relates to a particular pipe coupling including a nut having a hooked projection, the present invention may equally well be used on other standard pipe couplings. That is, even in standard couplings where the same aim of preventing contact of a pipe end with liquid travelling through the pipe is desired, the sealing member of the type described above may be used.

Although the invention has been shown and described in what is conceived to be the most practical and preferred embodiment, it is recognized that departures may be made therefrom within the scope and spirit of the invention, which is not to be limited to the details disclosed herein but is to be accorded the full scope of the claims so as to embrace any and all equivalent devices and apparatus.

In any claims that follow and in the summary of the invention, except where the context requires otherwise due to express language or necessary implication, the word “comprising” is used in the sense of “including”, i.e. the features specified may be associated with further features in various embodiments of the invention.

1. A sealing member for use in a pipe coupling assembly, said sealing member being adapted to engage an end of a pipe having an exposed metal surface, said sealing member comprising a pipe receiving portion adapted to sealably receive said end of said pipe to thereby prevent contact of said exposed metal surface with liquid travelling through said pipe.

2. The sealing member of claim 1, wherein said sealing member further includes an o-ring portion that is adapted to provide a seal between said pipe and said pipe coupling assembly.

3. The sealing member of claim 2, wherein said sealing member is integrally formed and adapted to be positioned within said pipe coupling assembly, whereby said pipe receiving portion is located in a position rearwards of said o-ring portion, said pipe receiving portion and o-ring portion being joined by an annular wall of predetermined longitudinal length.

4. The sealing member of claim 3, wherein said o-ring portion extends substantially outwardly from said annular wall and said pipe receiving portion extends substantially inwardly from said annular wall.

5. The sealing member of claim 1, wherein said pipe receiving portion is in the form of an annular channel including a base surface which extends inwardly from said annular wall substantially perpendicularly to the longitudinal axis of said coupling, said base surface adapted to abut with said exposed metal surface of said pipe end when said pipe is fully received within said pipe receiving portion.

6. The sealing member of claim 5, wherein said pipe receiving portion further includes an internal wall defining a central bore of said sealing member, said internal wall extending forwardly from the internal edge of said base surface, whereby when said pipe end is fully received within said pipe receiving portion, said internal wall lines said internal edge of said pipe end.

7. The sealing member of claim 5, wherein when said pipe end is fully received within said pipe receiving portion of said sealing member, said base surface and internal wall of said pipe receiving portion serve to prevent contact of liquid travelling through said central bore of said sealing member with said exposed metal surface of said pipe end.

8. The sealing member of claim 1, wherein said member includes a rearward end that is substantially cylindrical and includes a plurality of tetrahedrally shaped grooves disposed radially thereabout.

9. A pipe coupling assembly for connection of a pipe having an end with exposed metal, said pipe coupling assembly comprising:
a hollow body having an external thread extending at least in part therealong;
a nut threadably engaging said body external thread;
a sealing member including a pipe receiving portion; and
a deformable gripping members wherein upon tightening of said nut, a force is exerted on said gripping member both in the longitudinal and radial directions to thereby cause said gripping member to engage said pipe and drag it into said body, whereby said end of said pipe is received within said pipe receiving portion of said sealing member.

10. The pipe coupling assembly of claim 9, wherein said hollow body includes an inner surface and a gripping member abutment surface disposed rearwardly from said inner surface.

11. The pipe coupling assembly of claim 9, wherein said sealing member further includes an o-ring portion adapted to sit between said gripping member abutment surface and said gripping member, said o-ring portion adapted to compress when said longitudinal force is applied to said gripping member.

12. The pipe coupling assembly of claim 11, wherein said sealing member is an integrally formed structure, whereby said pipe receiving portion is disposed rearwardly from said o-ring portion and joined by an annular wall of predetermined length.

13. The pipe coupling assembly of claim 9, wherein said pipe receiving portion is in the form of an annular channel including a base surface which extends inwardly from said annular wall substantially perpendicularly to the longitudinal axis of the coupling, said base surface adapted to abut with said exposed metal surface of said pipe end when said pipe is fully received within said pipe receiving portion.

14. The pipe coupling assembly of claim 9, wherein said pipe receiving portion further includes an internal wall defining a central bore of said sealing member, said internal wall extending forwardly from the internal edge of said base surface, whereby when said pipe end is fully received within said pipe receiving portion, said internal wall lines said internal edge of said pipe end.

15. The pipe coupling assembly of claim 9, wherein said nut includes at one end an internal thread co-operable with said body external thread and including a hooked projection adapted to extend over at least part of said body inner surfaces said projection including a first inner surface generally parallel to said body inner surface, a second outwardly converging surface extending from the inner edge of said inner surface.

16. The pipe coupling assembly of claim 9, wherein said deformable gripping member includes a first surface generally parallel to said body inner surface and having a second outwardly converging outer surface extending from said first surface, said gripping member including radially inward barbs.

17. The pipe coupling assembly of claim 9, wherein said gripping member moves sufficiently radially inwardly that said gripping member second surface is caused to slide inwardly against said nut second surface until in a fixed position at which time said body reinforces said nut against any radial force.

18. The pipe coupling assembly of claim 9, wherein said gripping member is in the form of a collet that is split.

19. The pipe coupling assembly of claim 9, wherein the slope of said gripping member second surface is smaller than the slope of said nut second surface and is selected so that when said nut engages said gripping member and forces it into said body thereby compressing it, said slope of said gripping member second surface is generally the same as said nut second surface.

20. The pipe coupling assembly of claim 9, wherein said slope of said gripping member second surface in its rest state is approximately 37 degrees and said slope of said nut second surface is approximately 45 degrees.

21. The pipe coupling assembly as of claim 9, wherein said nut further includes an annular shoulder extending radially inwardly from the edge of said nut second surface, said stop adapted to be abutted by said gripping member when in its compressed state to thereby provide a resistive force for said gripping member moving longitudinally out of said body.

22. The pipe coupling assembly of claim 9, wherein the width of said nut second surface is greater than the width of said gripping member second surface to thereby accommodate said gripping member second surface sliding alongside said nut second surface as said nut is tightened while full surface contact between said two surfaces is maintained.

23. The pipe coupling assembly of claim 9, wherein said width of said nut second surface is approximately ⅓ greater than said width of the gripping member second surface.
